(19) United States
(12) Patent Application Publication
(10) Pub. No.: US 2014/0049371 A1
(43) Pub. Date: Feb. 20, 2014

(54) Door Control System Provided with Door Phone Device Addressing and Door Control Service and Controller, Door Phone Device and Communication Platform

(71) Applicant: Zeon Corporation, Taipei (TW)

(72) Inventor: Tien Chun Tung, Taipei City (TW)

(73) Assignee: Zeon Corporation, Taipei (TW)

(21) Appl. No.: 13/970,605

(22) Filed: Aug. 20, 2013

(30) Foreign Application Priority Data
Aug. 20, 2012 (CN) 201210296430.3

(51) Int. Cl. G07C 9/00

(52) U.S. Cl. CPC G07C 9/00007
USPC 340/5.61

(57) ABSTRACT

A door control system provided with door phone device addressing and door control service and a controller, a door phone device and a communication platform. The communication platform provides link between the controller and the door phone device. The communication platform, after allowing the controller to log in, stores controller identification information; or, the communication platform, after allowing the door phone device to log in, stores door phone device identification information; for the door phone device logged in to the communication platform to link with the controller to be searched by the IP connection method of the controller identification information, or for the controller logged in to the communication platform to link with the door phone device to be searched by the IP connection method of the door phone device identification information.

### CROSS-REFERENCE TO RELATED APPLICATIONS

This application claims the priority of China Patent Application No. 201210296430.30 filed on Aug. 20, 2012, in the State Intellectual Property Office of the P.R.C., the disclosure of which is incorporated herein by reference.

### BACKGROUND OF THE INVENTION

1. Field of the Invention

The invention relates to a method which provides visitor notification by a door phone device, especially a door control system with door phone device addressing and door control service and a controller, a door phone device and a communication platform.

2. Descriptions of the Related Art

As electronic technologies advance, various new appliance devices are developed successively to attract consumers. For example, a door phone device has been improved to be capable of video and audio transmission out of conventional simple voice transmission function for a user to master the identity of a visitor more easily. However, existing door phone devices still suffer from the following problem: voice or image transmission function is only useful as the user is at home, so that the user cannot know whether or not any visitor has visited as the user goes out.

Therefore, if the aforementioned door phone device is further equipped with network connection function for network link with a portable electronic device of the user, the user may still master anytime and anywhere whether or not any visitor has visited as the user goes out, and even acquire the identity of the visitor. However, there is a further problem: what input/output units a door phone device is provided with are door open button, microphone, speaker and display, and even more, only few keys for floor identification are added on the door phone device of a community building, such that under the situation of limited keys, parameters setting for network connection is impossible for such type of door phone device.

In addition, generally, as a network device without an user interface, such as router, network printer, network camera, is set or controlled, the user has to use a controller with an user interface, such as computer, smart phone, to enter an IP address preset in the device to be set or controlled, and the user has to enter sequentially various connection information, such as IP address, login IP address, login Account ID, login password etc. of the network device on the user interface of the controller. The network device may connect to the service server to be logged in only after long time entering to implement network services to be provided. If the network device is at a LAN (local area network) behind a router, the user may further have to set the router for the router to allow the network connection between the network device and the controller. To accomplish the aforementioned setting, the user has to know the fundamental concept about network. Also, as for general users, above network connection setting is pretty complex and difficult.

In conclusion, under the situation of limited input keys on existing door phone devices, what those skilled in the art desire to address is how to complete parameters setting of network connection for the door phone device, and create a communication platform for both the door phone device and the portable electronic device of the user quickly and conveniently to fulfill the user requirement of mastering visiting messages of visitors anytime anywhere.

### SUMMARY OF THE INVENTION

In view of the conventional technical problems mentioned above, one of the purposes of the invention is to provide a door control system providing with door phone device addressing and door control service and a controller, a door phone device and a communication platform to simplify networking setting procedure of the door phone device.

According to another purpose of the invention, a door control system providing with door phone device addressing and door control service and a controller, a door phone device and a communication platform are provided for an user to master visiting messages of visitors anytime and anywhere as the user goes out.

According to a further purpose of the invention, a door control system providing with door phone device addressing and door control service and a controller, a door phone device and a communication platform are provided, wherein the door phone device logs in to the communication platform with a single login Account ID/password such that the convenience for use by multiple users is available.

To achieve the above objective, the invention provides a door control system providing with door phone device addressing and door control service, including: a controller, which is installed with a doorbell APP (application program), which is executed to output a login Account ID/password and a control command; a door phone device, which is installed with a door control APP, and is provided with at least one doorbell trigger component, the door control APP being executed to receive the control command output from the controller that executes the doorbell APP, and set Internet connection of the door phone device and provide setting of login Account ID/password of the door phone device to perform arrangement process task; and a communication platform, which records APP IDs (application identifiers) of the doorbell APP and the door control APP, the controller being allowed to log in and an IP connection method being allowed to be published once the APP ID, the login Account ID/password of the controller are confirmed as valid to complete addressing task of the controller; also, the door phone device being allowed to log in with the login Account ID and the IP connection method of the door phone device being allowed to be published once the APP ID of the door phone device and the login Account ID/password thereof are confirmed as legal to complete the addressing task of the door phone device; and for the controller to find out the IP connection method used to connect to the door phone device according to the login Account ID of the door phone device, and set a receiving Account ID thereof for the door phone device, and the receiving Account ID being arranged in correspondence to the at least one doorbell trigger component, and for the door phone device to store the set receiving Account ID, so that as the at least one doorbell trigger component receives a trigger event, the door phone device provides a notification of the trigger event to the receiving Account ID arranged in correspondence to the at least one doorbell trigger component through the communication platform.

The invention further provides a controller, which connect with a door phone device logging to a communication platform through the communication platform, for the controller and the door phone device to perform interaction process, the door phone device being provided with a door control application module, the communication storing, for the door phone device that has logged in, door phone identification information, inclusive of login Account ID thereof, APP ID of the door control application module and IP connection thereof, the controller including: a communication module, used for connection with the door phone device and/or the communication platform; a doorbell application module, used for outputting login Account ID/password logging to the communication platform through the communication module and for outputting a control command to perform interaction with the door phone device; wherein, the communication platform stores, for the logged in controller, controller identification information, inclusive of login Account ID thereof, APP ID of the doorbell application module and IP connection method thereof, for the door phone device logging in to the communication platform to perform connection with the controller to be searched by the IP connection in the controller identification information of the known login Account ID, or for the controller logging in to the communication platform to perform connection with the door phone device to be searched by the IP connection method in the door phone device identification information of the known login Account ID, and for respective doorbell application module and door control application module to perform interaction process after both are connected.

The aforementioned door phone device is provided with at least one doorbell trigger component. As the login Account ID with which the controller logs in to the communication platform and the Account ID used by the door phone device are the same, the controller is regarded as a device administrator of the door phone device, while the interaction process between the doorbell application module and the door control application module includes: the doorbell application module setting a receiving Account ID for the doorbell trigger component of the door phone device, and the door control application module storing the receiving Account ID set by the aforementioned interaction process and in correspondence to the doorbell trigger component in a local end of the door phone device, such that once the doorbell trigger component receiving a trigger event, a notification of the trigger event being provided to the receiving Account ID arranged in correspondence to the doorbell trigger component through the communication platform.

In addition, the interaction process of the aforementioned doorbell application module and the door control application module further includes: the doorbell application module performing setting of adding or deleting the receiving Account ID for the doorbell trigger component of the door phone device, setting that whether the doorbell trigger component activates “automatic answering” and is able to upload recorded answering sound, setting that whether the doorbell trigger component records sound or image of visitor in the local end of the door phone device or setting the doorbell trigger component to store Account ID/password for clouding storage of sound and/or image of visitor; and the setting result of aforementioned interaction process being stored in the local end of the door phone device by the door control application module.

Moreover, as there are multiple receiving Account IDs for the doorbell trigger component of the aforementioned door phone device, one receiving Account ID from the multiple receiving Account IDs is set as the doorbell device administrator for the controller of the device administrator identity, said doorbell device administrator has the permission to check and set arrangement content of the doorbell trigger component.

Further, the door application module of the aforementioned door phone device receives the control command output from the doorbell application module of the controller, the control command includes connection information for connecting to the Internet and Account ID/password used to log in to the communication platform, for the door phone device to log in to the communication platform and complete arrangement process task successfully.

The invention further provides a door phone device, which performs connection with a controller through a communication platform, for the controller and the door phone device to perform notification process with respect to visit of visitor, wherein the controller is provided with a doorbell application module, the communication platform stores, for the controller that has logged in, controller identification information, inclusive of login Account ID thereof, APP ID of the doorbell application module and IP connection method thereof, the door phone device includes: a video and audio processor unit; a doorbell trigger component used to generate a trigger event of the visit of the visitor; and a control chip used to provide network connection function and having a door control application module, after logging in to the communication platform through the networking function, the communication platform stores, for the door phone device that has logged in, door phone device identification information, inclusive of login Account ID thereof, APP ID of the door control application module and IP connection method thereof, for the controller logging to the communication platform to use the known login Account ID of the door phone device to find out the IP connection method in the door phone device identification information through the communication platform, and perform connection with the door phone device to be controlled, wherein, the door control application module stores a receiving Account ID in correspondence to the doorbell trigger component, to provide the notification of the trigger event to the receiving Account ID arranged in correspondence to the doorbell trigger component through the communication platform as the doorbell trigger component receives the trigger event, and the receiving Account ID is the login Account ID used by the controller to log in to the communication platform.

The invention further provides a communication platform, used to provide a connection process for a controller and a door phone device, and the controller is installed with and executes a doorbell APP, while the door phone device is installed and executes a door control APP, the communication platform includes: a login module, used to allow for registration and recording of valid login Account ID/password, and recording valid APP ID of the doorbell APP, and recording valid APP ID of the door control APP, and after confirmation of the allowance for the control to log in, storing controller identification information, inclusive of login Account ID of the controller, APP ID thereof and IP connection, or after confirmation of the allowance for the door phone device to log in, storing door phone device identification information, inclusive of login Account ID of the door phone device, APP ID thereof and IP connection; and a search module, used for the door phone device that logs in to the communication platform to use the login Account ID/APP ID of the controller to find out the IP connection method in the controller identification information, and perform connection with the controller to be connected, or for the controller that logs in to the communication platform to use the login ID/APP ID and/or APP Resource of the door phone device to find out the IP connection method in the door phone device identification information and perform connection with the door phone device to be connected.

Therefore, the invention provides a door control system with door phone device addressing and door control service and a controller, a door phone device and a communication platform. Besides figuring out shortcomings that existing door phone devices cannot provide anytime and anywhere visit information of visitors effectively, the invention may further allow installation personnel of door phone devices to keep from remembering complex network connection setting procedure, and utilize the doorbell APP on the controller to connect to the door phone device, enter parameters necessary for the door phone device to connect to Internet, and provide automatically the login Account ID/password used by the controller to the door phone device, for the door phone device to be able to log in directly to the communication platform with the controller, and thus simplify the network connection setting of the door phone device. In addition, with the aforementioned arrangement method of the door phone device administrator and the doorbell device administrator, convenience and control flexibility for use of the door phone device may be further improved. Moreover, the communication platform only provide for login and searching with participation in specific application logic. For example, in the operation of the door control system according to the invention, only by that the controller and the door phone device know the login Account IDs and the APP IDs with each other, both connection methods may be searched automatically to perform connection with each other, and the interaction method therebetween may be determined without dependence on other servers or communication platforms. Briefly speaking, the communication platform neither needs to know nor participates in the interaction between the door phone device and the controller, such that the system complexity is simplified to improve operability.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of a system structure showing a door control system providing with door phone device addressing and door control service according to the invention.

FIG. 2 is a procedure flow chart with respect to starting a door control service process by a door phone device of the invention.

FIG. 3 is a procedure flow chart with respect to process as a door phone device receives a visitor trigger event according to the invention.

FIG. 4 shows a basic structure block diagram of a door phone device, a controller and a communication platform for implementing door phone device addressing and providing door control service.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

The door control system for door phone device addressing and door control service provided by the invention includes: a door phone device, a controller and a communication platform. The controller is used to set network connection function of the door phone device and for the door phone device to log in to the communication platform, and the controller or the door phone device acquires IP connection methods of each other through the communication platform. Therefore, network connection between both the door phone device and the controller is established for the door phone device, once receiving a visit event with respect to a visitor, to notify the controller through network or the controller may automatically connect the door phone device to control.

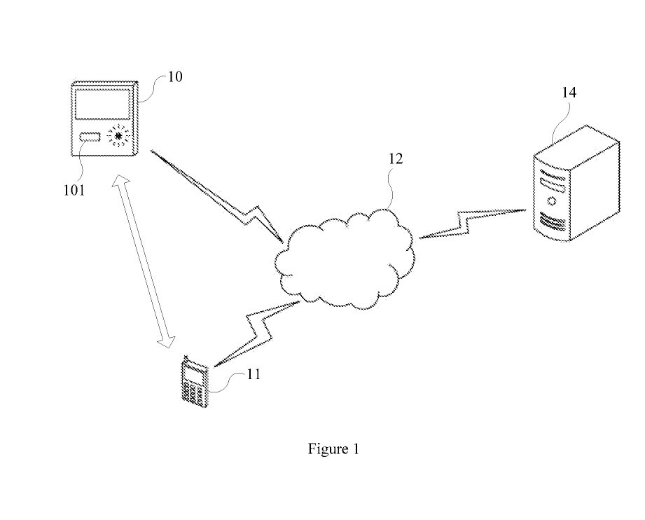

At first, refer to FIG. 1, which is a schematic view of a system structure showing a door control system provided with door phone device addressing and door control service according to the invention. Because no setup procedure such as network parameters and etc. is pre-installed when a door phone device 10 is delivered from plant, it cannot link to Internet 12 or log in to a communication platform in a normal circumstance. Generally, a controller with input/output interface, such as smart phone 11 or computer device and etc., performs setup, such as network connection login etc., for the door phone device 10. To simplify complex setup procedure, the invention will generate a wireless network link between the door phone device 10 and the smart phone 11 with a wireless local area network function. The wireless local area network function may be, for example, Wi-Fi technology based on IEEE 8092.11 standard. In other words, the door phone device 10 may be a Wi-Fi device. Thereby, the smart phone 11 is utilized to locate the door phone device 10 through the wireless function and set parameters of Internet link information and login Account ID/password thereto.

More specifically, the communication platform 14 has stored APP IDs of a variety of valid network devices in advance. This is because a variety of network devices are served or managed by the communication platform 14. For convenient identification and coordination between devices, the communication platform 14 registers APP IDs of all valid network devices. Said “APP IDs” indicate APP identifiers (application program identifiers) planned and specified integrally in advance by an administrator of the communication platform 14 for APPs executed by each of the valid network devices logging in to and running on the communication platform 14. Therefore, each valid APP knows its own APP ID, and APP IDs of other APPs to be communicated and operated with each other. For example, the APP ID of a door phone device (that is, the APP identifier of the door phone device) is assigned 400, while the APP ID of a controller used to manage the door phone device is assigned 500. With a login Account ID of a device logged in to the communication platform 14, and an APP ID of the device, it is convenient for different network devices logged in to the communication platform 14 to search for each other. For example, a network device, a user desires to manage, is a door phone device (with APP ID as 400) of a certain building in a certain community, while the user is a property management company. The property management company uses his own login Account ID “B” to log in to the communication platform 14 on the controller (with APP ID as 500) end of the door phone device in advance, followed by entering the login Account ID “A” of the door phone device to be controlled on the controller. The APP running on the controller end will search for a unit with “login Account ID as A and APP ID as 400” through the communication platform 14 to locate door phone device that logs in with Account ID “A” and APP ID “400” on the communication platform 14 for the controller to acquire IP connection method of the door phone device on the communication platform 14 and initiate connection, and perform control of the door phone device. As a result, network devices of different functions are categorized with different APP IDs (that is APP identifiers). Therefore, as for the communication platform, it will record at least the login Account ID of network device and the APP ID thereof for each of the network device that logs in. In addition, the program content of the APP (with APP ID as 500) has already set in advance that the object to be searched and coordinated by APP ID 500 is APP ID 400, and the program content in the APP of the door phone device may also declare in advance that only the service request proposed by APP ID 500 will be accepted. Briefly speaking, the APP ID of APP operated by each network device is assigned in advance by a communication platform administrator, such that different or the same APPs of different network devices may locate IP connection methods of each other and further perform mutual connection and coordination tasks with login Account IDs of network devices that log in and APP IDs thereof through the communication platform. In the following example, a smart phone 11 is used as a controller to set network connection of the door phone device 10, but the invention is not limited thereto.

From above, the communication platform 14 identifies a network device that logs in with at least the login Account ID of the network device and the APP ID thereof. Therefore, the smart phone 11 has to be installed with and execute a doorbell APP, while the door phone device 10 has to be installed with and execute a door control APP. After the smart phone 11 and the door phone device 10 log in to the communication platform 14, both of them utilize the login Account ID and the APP ID of the opposite side to locate IP connection methods with each other on the communication platform by the doorbell APP and the door control APP installed respectively to perform communication and operation. In the example, for the door phone device 10 to have network connection function, the door hone device 10 is provided with a control chip for executing network connection function, while the aforementioned door control APP may be stored in the control chip.

At first, after the user enters login Account ID and password through the doorbell APP on the smart phone 11 and logs in to the communication platform 14 successfully, the communication platform 14 records controller identification information, inclusive of the login Account ID and the APP ID of the doorbell APP and the IP connection method thereof. Next, the user may choose to the function of managing new device via the doorbell APP. Meanwhile, the smart phone 11 starts a wireless function, and searches for a wireless SSID (service set identifier) of the door phone device named after a default method. The default method naming is, for example, named after the identifier of the door phone device, while the aforementioned identifier may be a hardware identifier or a product serial number. Hardware identifier is taken as example for explanation below. On the other hand, the door phone device 10 has also to start the wireless function, and publishes the SSID using its own hardware identifier as the default naming method, for the smart phone 11 to search, and wait for the smart phone 11 to connect therewith. It is noted that, besides the wireless function of the door phone device 10 started by users themselves, for example, an user may press the reset function key on the door phone device 10 for the door phone device 10 to enter a “waiting for device wireless link setup” state; generally speaking, as the door phone device 10 is started the first time, because no parameter setting has been specified, for example, Internet connection parameters or other control parameters of the device etc., Internet connection is impossible, thus, the door phone device 10 will automatically enter a “waiting for device wireless link setup” state. Therefore, the door phone device 10 may receive setting parameters transmitted from the smart phone via the wireless function, and the setting parameters include: connection information and login Account ID/password to log in to the communication platform. Particularly, the aforementioned login Account ID/password does not need the user at the smart phone 11 to enter, but the doorbell APP of the smart phone 11 automatically provides the login Account ID/password it uses to log in to the communication platform 14 to the door phone device 10, such that the door phone device 10 may connect to the communication platform 14 with the connection information, followed by logging in to the communication platform 14 with the login Account ID/password. After the communication platform 14 is verified successfully, the door phone device publishes its own “login Account ID”, “APP ID” and “IP connection method” on the communication platform 14 to complete the setup task for the door phone device, and simultaneously, for other doorbell APPs logged in to the communication platform to search and address the IP address of the door phone device to perform connection according to the login Account ID and the APP ID of the door phone device 10 for the doorbell APP to set the door phone device subsequently.

In addition, there are many aforementioned SSID default naming methods, which may generally be composed of APP ID and hardware identifier of a door phone device (but not limited thereto). For example, in “door_{—}2D3415A97B92”, “door” indicates the APP ID of the door phone device, and “2D3415A97B92” is the MAC address for the network card of the door phone device. A user knows that the network device represented by this series of characters indicates a door phone device from the word “door”. The MAC address, in general, is printed on the casing of the door phone device, or written in the attached user manual document, so that once the user has to set the door phone device, the user may identify the door phone device to be set if there are multiple door phone devices to be set at the same time.

From above, because the door phone device 10 utilizes the login Account ID/password provided by the smart phone 11 to log in to the communication platform 14 successfully, that is, the door phone device 10 and the smart phone 11 use the same login Account ID/password to log in to the communication platform, after the smart phone 11 logs in to the communication platform 14 with the doorbell APP, the login Account ID it uses and the APP ID of the door phone device to be searched are utilized to locate the IP connection method of the door phone device and connect to the door phone device. Meanwhile, the door phone device recognizes that the doorbell APP using the same login Account ID is the device administrator of the door phone device 10, so that it allows the smart phone to perform control management to the door phone device.

Further, if not only one trigger component 101 is on the casing of the door phone device 10, for example, the door phone device 10 is installed on a door of a building, there may be multiple trigger components 101, as activated by a visitor, each different trigger component will trigger a different doorbell number event. In practice, different trigger components are represented by different doorbell numbers, and each of the doorbell numbers corresponds to each residence in the building. The smart phone 11 with device administrator identity may assign a receiving Account ID for each of different doorbell numbers, such that as the trigger component 101 is activated, an APP on the door phone device may locate the receiving Account ID corresponding to the doorbell number triggering the doorbell event according to the triggered doorbell event, the door phone device locate the IP connection method of the doorbell APP (that is, the smart phone executing the doorbell APP and logging in to the communication platform) logged in to the communication platform with the receiving Account ID on the communication platform according to the receiving Account ID and the APP ID of the doorbell APP, then the door phone device connects to the doorbell APP of the smart phone, and issues the doorbell event (that is, visit notification with respect to a visitor) to the doorbell APP of the smart phone. Because the door phone device 10 that logs in successfully has published the door phone device identification information of ifs login Account ID, APP ID and IP connection method on the communication platform, after the smart phone 11 with the device administrator identity logs in to the communication platform 14 with the login Account ID/password the same as the door phone device 10, the identification information of the door phone device 10 using the same login Account ID may be located, and further the IP connection method of the door phone device 10 may be acquired, for the smart phone 11 and the door phone device 10 to connect directly. After that, the smart phone 11 may be used to set the receiving Account ID of each doorbell number for the door phone device 10, and the door phone device 10 may be used to store the doorbell number represented by each (each set) of the trigger components set by the administrator and the receiving Account ID corresponding to the doorbell number.

The aforementioned receiving Account ID may be a null number, one or multiple. For example, as the aforementioned device administrator is the owner of the residence, the door phone device is installed on the door of a residence; the door phone device may need only one trigger component, and the receiving Account ID corresponding to the trigger component is the login Account ID of the doorbell APP 11 on the smart phone used to log in to the communication platform 14; or, if the aforementioned device administrator is a father in the residence, besides the login Account ID used by the smart phone 11 to log in to the communication platform 14 (that is, the Account ID of the father), the receiving Account ID may also include Account IDs of other members such as mother or grandmother. Further, if the door phone device is installed on a door of a building, the door phone device may have multiple trigger components, each trigger component (or a set of trigger components) uses different doorbell numbers to represent different residence doorbells, respectively, and the administrator may assign and store one or multiple receiving Account IDs for each doorbell number in the door phone device.

In conclusion, the smart phone 11 installed with and executing the doorbell APP is not only parameters setup tool used to set connection information of the door phone device 10 and login Account ID/password used to log in to the communication platform, but also has a function for the device administrator to set the receiving Account ID of the trigger component on the door phone device 10, for the smart phone 11 or the controller logged in to the communication platform with the receiving Account ID to receive trigger component activation notification sent from the door phone device, to further perform the function of video and audio communication with the visitor at the door phone device 10. Therefore, the door control system of door phone device addressing and door control service provided by the invention searches for the IP connection methods of the doorbell APP of the mobile phone and the door control APP of the door phone device logged in to the communication platform by the communication platform 14, such that the door phone device 10 and the smart phone 11 may locate each other and establish connection therebetween, and communicate with each other by the doorbell APP and the door control APP on the door phone device 10 and the smart phone 11, respectively, for the user to monitor and interact with visitor at the door phone device 10 through the smart phone 11 anytime and anywhere.

From above, the door control system of the invention utilizes the controller to arrange the internet link of the door phone device with, for example, a Wi-Fi link method, and to assign the login Account ID/password of the door phone device. After the door phone device logs in to the communication platform through the door control APP automatically, as the controller of the device administrator utilizes the installed and executed doorbell APP to log in to the communication platform with the same Account ID, the login Account ID of the controller itself is used to locate the IP connection method of the door phone device using the same login Account ID to log in to the communication platform. After both of them are connected, the doorbell APP of the controller with device management administrator will display “Manage” button. Once the user press the “Manage” button, a management interface for the door phone device may be seen on the controller. Moreover, the functions of the management interface include setting contents for setup, for example, the following notification table, automatic answering setting, answering audio setting, or storage of visitor video and audio in the local end of the door phone device or cloud. Further, the door control APP of the door phone device completes the setup according to the arranged contents sent from the controller for the door phone device to perform door control process according to the arranged contents. Therefore, for the door control system of the invention, only the controller and the door phone device are used to determine the interaction method therebetween without depending on the communication platform. As a result, the door control system of the invention may pin down the complex problems of the system effectively and simultaneously make improvement.

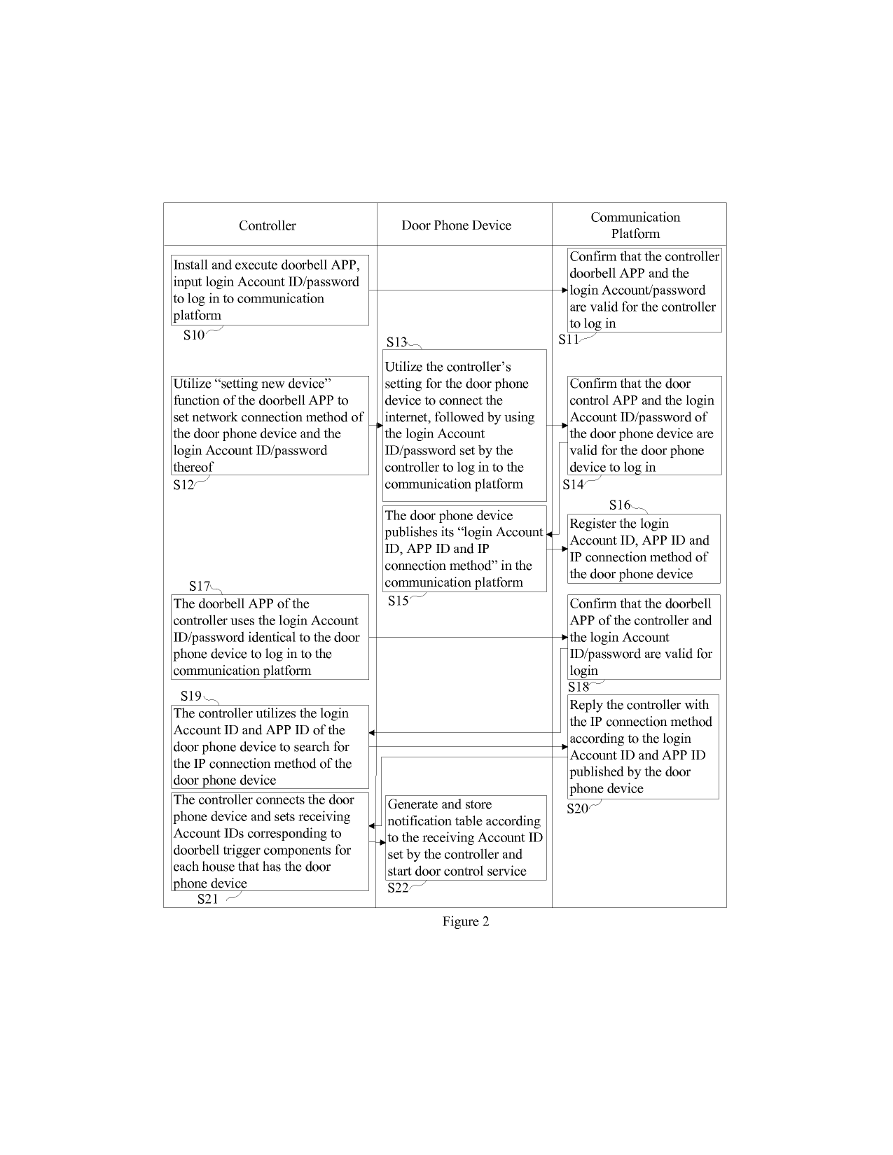

Next, as shown in FIG. 2, which is a flow chart explaining the process that the door phone device starts the door control service. To understand more clearly the starting principle for the control service of the invention, a door phone device on a door of a community building is taken as an example for statement here. Moreover, it is the device administrator who has permission to manage, such as the property management company or the construction company and etc., who utilizes the controller installed with the doorbell APP to perform setup with respect to network connection and communication platform login for the door phone device.

At first, step S10 is performed, the aforementioned device administrator utilizes the controller installed with and executing the doorbell APP to enter login Account ID and password for the controller to perform the process of communication platform login, followed by performing step S11.

In step S11, once the communication platform confirms that the doorbell APP and the login Account ID/password of the controller are valid, it allows the controller to log in, followed by performing step S12. The doorbell APP of the controller logged in to the communication platform publishes its login Account ID, APP ID (that is, doorbell APP identifier) and IP connection method on the communication platform to generate identification information of the controller.

In step S12, the device administrator selects “device setup” function on the doorbell APP. At the same time, the controller starts a wireless function, and searches for a wireless SSID (Service Set Identifier) of the door phone device named as a default method. On the other hand, as mentioned previously, the door phone device 10 also has to start the wireless function, and publish information that can be used for recognizing identify thereof, for example, APP ID and/or hardware identifier, the SSID with default naming method using such information, thereby for the controller to search, and wait for the controller to connect therewith. However, it is not limited to wireless connection, wired connection is possible. In other words, it depends on the structural resource of the door phone device and the controller. After the controller locates the door phone device and connects therewith, it sets parameters of connection information and login Account ID/password for the door phone device, followed by performing step S13.

In step S13, after the door phone device receives the parameters sent from the controller through the wireless function, it connects to the communication platform with the connection information in the parameters. Subsequently, the login Account ID/password set by the controller is used to perform process of communication platform login, followed by performing step S14.

In step S14, once the communication platform receives the login request from the door phone device, it performs validity check immediately, and, allows the door phone device to log in after verifying that the door control APP of the door phone device and the login Account ID/password are valid, followed by performing step S15. In addition, to manage the door phone device logged in to the communication platform effectively and securely, the communication platform may register multiple sets of identifiers of valid door phone devices for the communication platform to verify the door phone device that has logged in to verify if the door phone device has been authorized. The aforementioned identifiers may be hardware identifiers or product serial numbers. Any identifier capable of identifying the uniqueness of the door phone device is applicable. Generally, before the door phone device is delivered from plant or under commercial activity such as selling, the commercial activity host provides the identifier of the door phone device to the administrator of the communication platform for the administrator to register the identifier of the door phone device on the communication platform, and verify the validity of the door phone device with the identifier. Thus, unauthorized door phone devices are effectively kept from logging in to the communication platform arbitrarily. Also, the aforementioned validity check for the door phone device performed by the communication platform is not limited to the check on the door control APP, and the login Account ID/password of the door phone device, but includes the validity check for the aforementioned unique identifier of the door phone device. The unique identifier of the door phone device is provided to the communication platform automatically by the door control APP on the door phone device. In other words, depending on the service requirements between the communication platform and the door phone device vendors, the door phone devices logging in to the communication platform may be monitored and managed effectively to keep unauthorized door phone devices from using the services provided by the communication platform illegally.

In step S15, after the validity of the door phone device is confirmed by the communication platform, the door phone device logs in to the communication platform to publish the login Account ID and the APP ID and the IP connection method of the door phone device on the communication platform such that new device setup task is completed, followed by performing step S16.

In step S16, the communication platform registers the login Account ID, APP ID and IP connection method of the door phone device, followed by performing step S17. That is, the communication platform utilizes the login Account ID of the door phone device, the APP ID of the door phone device and the IP connection method thereof to store identification information of the door phone device that has logged in, for the controller logging in subsequently to search for the IP connection method of the door phone device to be searched according to the login Account ID/APP ID of the door phone device, and further connect with the door phone device to set up, as stated below in detail.

In step S17, the device administrator performs the process of logging in to the communication platform with the aforementioned login Account ID/password used by the door phone device to log in to the communication platform through the doorbell APP of the controller, followed by performing step S18. It is noted that, for the controller desired to log in to the communication platform, if it uses the login Account ID identical to the door phone device to log in to the communication platform, as the controller connects to the door phone device with the same login Account ID, the door phone device recognizes that the controller is the device administrator of the door phone device and allows the controller to perform management operation. Also, it is particularly noted that the communication platform is not responsible for the task with respect to whether or not the login Account ID used by the controller has the device administrator identity; it is the door phone device that has logged in to the communication platform to discover that the controller logs in with the same Account ID, thereby the controller is allowed to perform management or control for the door phone device. Briefly speaking, the communication platform is only responsible for providing search between the controller and the door phone device that have logged in, while it is the APPs installed on and executed by the controller and the door phone device to implement the operation method after login.

In addition, for the identity of the device administrator, besides users such as aforementioned property management company or construction company, it may also be a member in a residence, depending on the installation environment of the door phone device. More specifically, if the door phone device is installed on a door of a building, there are definitely multiple door buttons installed on the door phone device for a visitor to press with respect to a certain residence is visited. Therefore, the device administrator who may know the login Account ID/password of the door phone device and log in to the communication platform to manage the door phone device is exactly the property management company of the building. Besides, if the door phone device is installed on a door of an individual residence, only one single trigger component is necessary on the door phone device for the visitor to active. Therefore, the device administrator who may know the login Account ID/password of the door phone device and may log in to the communication platform to manage the door phone device is exactly a member of the residence, for example, a parent.

In step S18, once the communication platform confirms that the doorbell APP of the controller and the login Account ID/password are valid, the controller is allowed to log in, followed by performing step S19.

In step S19, the controller that logs in to the communication platform utilizes the login Account ID and APP ID of the door phone device to search identification information in compliance with the door phone device from the communication platform, and acquire the IP connection method of the door phone device to be searched, and further may connect therewith, followed by performing step S20.

In step S20, the communication platform replies the controller with the IP connection method of the door phone device to be searched according to the login Account ID, APP ID and IP connection method published by the door phone device, followed by performing step S21.

In step S21, the controller establishes connection with the door phone device to be searched according to the IP connection method replied by the communication platform to set the receiving Account ID corresponding to the trigger component of each residence on the door phone device, followed by performing step S22. Here, the so called receiving Account ID is the login Account ID the controller uses to log in to the communication platform, the door phone device to be searched by the controller will utilize the login Account ID used by the controller and the APP ID thereof to check its access permission. The relationship between the receiving Account ID and the controller will be discussed in detail later.

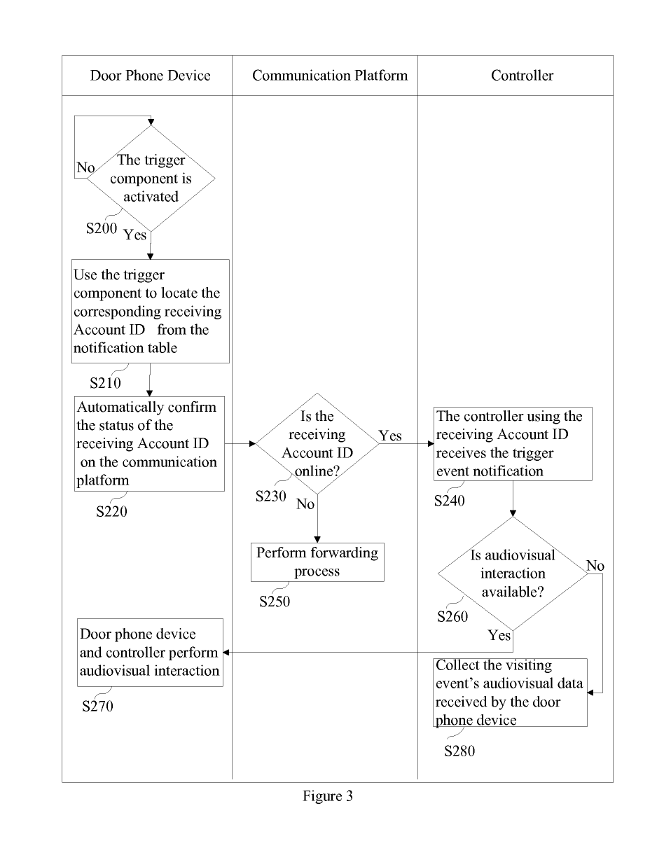

In step S22, the door control APP of the door phone device generates and stores a notification table according to the controller with respect to the setup result for the receiving Account ID of the trigger component of each residence. Moreover, the notification table includes each (each set) of the trigger components and the corresponding one or more receiving Account IDs. The door control function is launched once the storage is completed. The door control function will be stated in detail below in connection with FIG. 3. It is noted that, because the door phone device is installed on a door of a building in this example, a table generation method is used by the door phone device to register receiving Account IDs of each residence. Besides, if the residence of the building is empty or the owner of the residence does not want to use the service of door control service, the receiving Account ID for the trigger component of that residence may be unnecessary, that is, the receiving Account ID of the trigger component will be set as a null number. Further, if the door phone device is placed on a door of an individual residence, only the receiving Account ID corresponding to a single trigger component is necessary to be stored by the door phone device.

In addition, in the steps S21 and S22, the so called receiving Account ID indicates the login Account ID used by the controller, which is installed with and executes doorbell APP and logs in to the communication platform, to log in to the communication platform. Briefly speaking, if the login Account ID of the controller, which is installed with and executes doorbell APP, used to log in to the communication is the same as the login Account ID of the door phone device used to log in to the communication platform; it indicates that the controller is a device administrator that may manage or set the door phone device, that is, the aforementioned property management company of a community or a member, who has management permission, of an individual residence. If the login Account ID of a controller, which is installed with and executes doorbell APP, used to log in to the communication platform differs from the login Account ID used by the door phone device, but is a receiving Account ID set by a certain doorbell number of the door phone device, it indicates that the controller is a terminal device that is notified with an event of visiting received by a certain doorbell number of the door phone device and may interact with the visitor. Besides, as the controller, that logs in to the communication platform with the login Account ID of the door phone device, sets the aforementioned receiving Account for the door phone device, the receiving Account ID may also be set as the login Account ID used currently by the controller for the controller that logs in to the communication platform with the login Account ID of the door phone device to own dual identities with respect to management and being notified with visiting. In other words, depending on user requirement, whether or not the login Account ID used by the controller and the login Account ID used by the door phone device are the same may affect the access permission of the controller with respect to the door phone device.

Subsequently, as shown in FIG. 3, which illustrates a procedure flow chart for a process as the door phone device receives a trigger event of visiting according to the invention. Also refer to FIG. 2, the door phone device placed on a door of a building has stored a notification table with trigger components of each residence and corresponding receiving Account IDs thereof. It is noted that, the aforementioned trigger component of each residence is not limited to the trigger component dedicated to the residence arranged individually in terms of each residence, it may also be a button combination of a number symbol “0˜9” in conjunction with a special symbol “−”, together with a call button, to represent a doorbell of a residence. For example, button “16-1” may be pressed if the resident of address 16-1 is visited, button “16-2” is pressed if the resident of address 16-2 is visited, button “17-1” is pressed if the resident of address 17-1 is visited, followed by pressing the call button to generate a trigger event for the trigger component of that residence, or inputting voice recognition as identification for trigger component of each residence. In other words, the notification table is generated with the doorbell number of the trigger component for each residence and the receiving Account ID corresponding to the doorbell number. At first, step S200 is performed, the door phone device decides whether the trigger component on the casing thereof is activated, step S210 is performed if triggered; vice versa, on the contrary, the determination of trigger continues.

In step S210, the door phone device locates the receiving Account ID corresponding to the doorbell number from the notification table according to the doorbell number of the button that is triggered, followed by performing step S220.

In step S220, the door phone device automatically identifies the online status of the doorbell APP (controller) logged in with the receiving Account ID on the communication platform according to the receiving Account ID that is located, followed by performing S230 for determination procedure. Subsequently, step S240 is performed if the doorbell APP is running; otherwise, step S250 is performed, in which the communication platform performs forwarding process for the trigger event received by the door phone device. For example, the receiving Account ID is used to log in to the communication platform through the doorbell APP in the controller, the communication platform may be requested to bind the receiving Account ID and the controller, in one preferred example, the controller is a smart phone, after that, if a doorbell trigger event occurs, as the door phone device desires to notify the doorbell event for the receiving Account ID, the communication platform may be requested to push the doorbell event to the receiving Account ID, the communication platform locates the mobile phone ID bound with the receiving Account ID, and utilizes the push mechanism provided by mobile phone system vendor to push the doorbell event to the bound mobile phone end to prompt the mobile phone user of the occurrence of doorbell event, and the mobile phone user may ignore or may start the doorbell APP to connect to the door phone device. If the mobile phone user does not turn on the mobile phone, the prompt pushed by the mobile phone system vendor will also be received automatically the next time the mobile phone is turned on. Besides, the door phone device administrator may further set the doorbell number as “automatic answering mode”. Therefore, as a visitor press the doorbell button set with the “automatic answering mode”, the door phone device may play the audio recording content set in correspondence to the doorbell number and start audio and video recording according to the arrangement of the doorbell number to ask the visitor to perform visitor video and audio recording process through the door control APP. At last, the result of the video and audio recording process may be stored in the door phone device, or stored in a cloud storage device prepared for the user using the controller of the receiving Account ID to acquire visiting information of the visitor. In addition, as the door phone device sets the doorbell number as “automatic answering mode”, the door phone device may still send doorbell event to the receiving Account ID of the doorbell number in terms of setting. Particularly, the aforementioned automatic answering mode is arranged for a certain doorbell number in the door phone device, instead of being arranged for a certain receiving Account ID. For example, if the door phone device on a door of a building sets “automatic answering mode” for doorbell number of trigger component of room A on the 12th floor, as a visitor activates the trigger component of room A on the 12th floor for the door phone device, voice is played automatically and the recording starts, the door phone device will also send a notification to the receiving Account ID if the doorbell number is also arranged with the receiving Account ID. Moreover, as above, if the receiving Account ID does not log in to the communication platform or the controller using the receiving Account ID is not turned on, the aforementioned forwarding process will be performed. In addition, because a mobile phone is used as example for the aforementioned controller, the forwarding process may be provided by the aforementioned mobile communication service system. Nevertheless, if the aforementioned controller is a laptop, the forwarding process may be provided by the communication platform. In other words, the aforementioned forwarding process may be implemented by different systems according to function and purpose of the controller.

In step S240, the door phone device searches for the IP connection method of the controller using the receiving Account ID on the communication platform, sends a doorbell trigger event notification to the doorbell APP of the controller using the receiving Account ID, the controller receives the notification of the trigger event, followed by performing step S260.

In step S260, the doorbell APP of the controller asks the user using the controller whether to accept audiovisual interaction, followed by performing step S270 if the user agrees to accept the audiovisual interaction; or, followed by performing step S280 if the user disagree to accept the audiovisual interaction, in which the controller may still collect the visiting event's audiovisual data received by the door phone device, while the door phone device will not reply the visitor with the status of the controller, that is, the status of the door phone device is the situation that the resident has no answering.

In step S270, the doorbell APP of the controller and the door control APP of the door phone device connect and operate mutually, for the door phone device and the controller to perform the audiovisual interaction, such that the user at the controller may obtain information about the visitor who visits, and may perform the audiovisual interaction with the visitor at the door phone device.

As for door phone identification information, besides the aforementioned login Account ID, APP ID and IP connection method, APP Resource may also be included. To further clarify the function of the APP Resource, one more example is taken below. It is assumed that a user of a controller has residences in place A and place B. The user installs door phone devices on doors of residences in the two places, respectively. Login Account IDs of the two door phone devices are both A, APP IDs thereof are both “400”. The APP Resources of the two door phone devices may be sets as “place A” and “place B”, respectively, in advance by the user as the two door phone devices log in to the communication platform. Subsequently, the user may utilize the controller installed with and executing the doorbell APP to log in to the communication platform with login Account ID “A” to search the door phone device to be controlled, that is, to search the door phone that logs in with the same login Account ID “A” such that the controller may locate two door phone devices using login Account ID “A” for logging in to the communication platform, while their identification information are (1) “(login Account ID) A/(APP ID) 400/(APP Resource) Place A/(IP connection method) X”; and (2) “(login Account ID) A/(APP ID) 400/(APP Resource) Place B/(IP connection method) Y”. In addition, the doorbell APP has been set in a program, the APP ID it searches is 400. Therefore, as for the user at the controller end, the only condition to be searched is the login Account ID of the door phone device such that one or more door phone devices in compliance with the search condition may be located automatically. As a result, door phone identification information may have different data content in response to user requirement or arrangement environment of the door phone device.

Besides, after the controller logs in to the communication with a login Account ID with management permission, it may set accessible Account IDs of door phone devices using the same login Account ID. The accessible Account ID is, for example, the aforementioned on or more receiving Account IDs set by the device administrator for doorbell number of each residence, such that other login Account IDs are not allowed to connect and use this door phone device. Therefore, the number of users who may use the door phone device may be increased or decreased depending on usage requirement. For example, as for a home, grandfather, grandmother, father and mother of the home members may log in to the communication platform through their own controllers with their own Account IDs, the communication platform may be logged in at the same time or different time to use the same door phone device, wherein the login Account ID used by the father serves as the login Account ID of the door phone device, so that the father is the door phone device administrator, who may further set receiving Account IDs capable of using the doorbell trigger event notification of the trigger component on the door phone device for, for example, the login Account IDs of the grandfather, grandmother and mother may also serve as receiving Account IDs of the trigger component, to allow other members in the home to learn the identity of the visitor who visits together at any time; in contrast, other login Account IDs that are not set for the doorbell trigger event notification of the trigger component are not allowed to connect to the door phone device.

Besides, as the login Account ID used to log in to the communication platform and for the controller to use is not door phone device administrator identity, that is, the login Account ID is not a login Account ID used by the door phone device, if the login Account ID has been set as a receiving Account ID of a doorbell number for a certain trigger component on a certain door phone device, after the login Account ID logs in to the communication platform, it may be allowed to connect to the door phone device, and to check the settings content regarding to the doorbell number set with the receiving Account ID in the door phone device. However, only the owned doorbell number may be checked, settings contents of other doorbell numbers cannot be checked.

Additionally, besides the aforementioned door phone device administrator identity, the invention further provides setting for doorbell device administrator. For example, the login Account ID “A” for the controller to use is set as a receiving Account ID of a doorbell number 100 for a trigger component on a certain door phone device, further, as the login Account ID “A” has been set as administrator identity of the doorbell number 100 by the door phone administrator, after the login Account ID “A” connects to the door phone device, it has the permission to check and set all settings contents of the doorbell number 100, including, for example, adding or deleting other receiving Account IDs of the doorbell number 100, setting the doorbell number 100 with respect to whether start “automatic answering” and upload answering audio recorded, setting the doorbell number 100 with respect to whether or not record visitor video and audio in the local end of the door phone device, setting Account ID of cloud storage for the doorbell number 100 (the login Account ID may be used to store visitor video and audio recorded etc. that are uploaded). From above, the door phone device administrator not only sets the receiving Account ID of the doorbell number, but also sets a certain receiving Account ID as the doorbell device administrator identity, for the receiving Account ID belonging to the doorbell device administrator to manage itself its own doorbell number arrangement, that is, the doorbell number's respective settings may be changed arbitrarily, while other receiving Account IDs of the doorbell number may only browse the doorbell number arrangement without the capability to modify the doorbell number arrangement.

In addition, the setting method of the aforementioned doorbell device administrator may, for example, use the “first” receiving Account ID of the doorbell number for setting. Of course, the receiving Account ID of the doorbell number may be also attached with a flag to utilize the flag setting result to identify that a certain one among the receiving Account IDs is the doorbell device administrator. In other words, any method that may identify that a certain receiving Account ID among the receiving Account IDs of the doorbell number is the doorbell device administrator is adoptable.

The convenience of using the door phone device may be improved by the aforementioned settings method of the door phone device administrator and the doorbell device administrator. For example, as for the door phone device installed on a door in a building, with the aforementioned doorbell device administrator, the property management company belonging to door phone device administrator identity no more has to manage information about visitor who presses doorbell for each residence or set settings content for each doorbell number, but the resident member belonging to doorbell device administrator is responsible for management and setting. Therefore, not only the workload of the property management company is reduced, but also the flexibility of control for each resident with respect to the door phone device is available. Besides, for management with respect to security, the login Account ID belonging to door phone device administrator identity may reset settings content of any doorbell number. In other words, the permission of the login Account ID belonging to the door phone device administrator identity is larger than the login Account ID belonging to the doorbell device administrator identity.

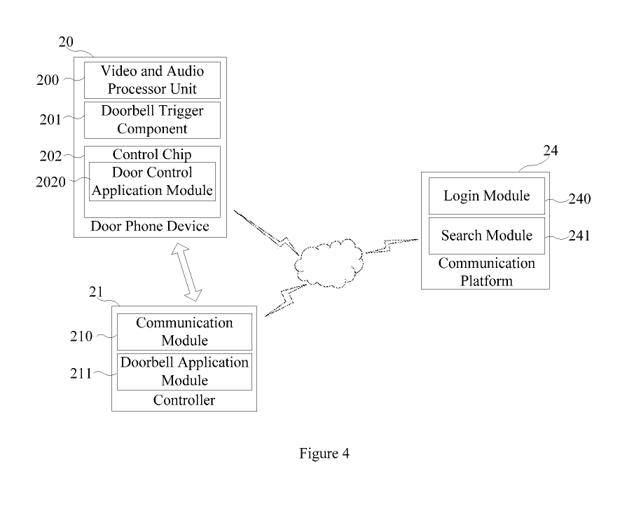

To implement the process of starting door control service by the door phone device according to the invention as shown in FIG. 2, the invention further provides a door phone device, a controller and a communication platform. As shown in FIG. 4, it shows a basic structure block diagram with door phone device, controller and communication platform for implementing door phone device addressing and providing door control service. The door phone device 20 includes a communication module 210 and a doorbell application module 211. The communication platform 24 includes a login module 240 and a search module 241. It is noted that, to simplify drawing and explanation, only function modules regarding to major features of the invention are explained. Statements about other function modules, for example, power module or storage unit etc. will not be explained.

A component video and audio processor unit 200 of the door phone device 20 is a microphone, speaker unit and lens unit for an user at the controller 21 and a visitor at the door phone device 20 to perform audiovisual interaction process. The doorbell trigger component 201 of the door phone device 20 is used to generate a trigger event for event of visiting; it may be, for example, a trigger component for the visitor who visits to generate a trigger event. The number of the trigger components may depend on arrangement environment of the door phone device 20. For example, if the door phone device is placed on a door of a residence, the trigger component number is only one. If the door phone device is placed on a door of a building, the trigger component number is multiple, and dedicated trigger components may be placed, respectively, in terms of residence number, or different default trigger component combination method may represent trigger component of each residence, and even further voice method may replace trigger component of each residence. Briefly speaking, the doorbell trigger component 201 represents a trigger component of a certain residence, and may identify the trigger for the trigger component of a certain residence by single-trigger component input method, multiple trigger component combination input method or voice recognition input method.

The control chip 202 of the door phone device 20 is used to provide networking function, and has a door control application module 2020, which is the aforementioned door control APP. The networking function provided by the control chip 202 is used for communication with external controller 21. By using control command sent from the controller 21 to arrange login Account ID/password and connect to external communication platform 24, after the communication platform 24 confirms the login Account ID/password and APP ID (that is, program identifier) of the door control APP with permission obtained to be allowed to log in, a service unit in the communication platform is launched to publish door phone device identification information, inclusive of the login Account ID, APP ID and IP connection method of the door phone device 20, for the controller 21 to locate the IP connection method of the door phone device 20 according to the login Account ID and the APP ID used by the door phone device, such that the controller 21 may connect with the door phone device 20. Subsequently, the door phone device 20 utilizes the door control APP to receive and store the receiving Account ID set by the controller 231, while the receiving Account ID is set in correspondence to the doorbell trigger component 201, such that as the doorbell trigger component 201 receives a trigger event, the controller that searches for and connects to receive the Account ID login through the communication platform 24 establishes audiovisual interaction between the video and audio processor unit 200 and the controller 21 using the receiving Account ID to implement door control service. The aforementioned receiving Account ID is the login Account ID of the controller 21 used to log in to the communication platform, wherein, as the login Account ID used by the controller is the same as the login Account ID used by the door phone device 20 for logging in to the communication platform 24, it indicates that the controller 21 is the device administrator of the door phone device 20, while there may be one or more receiving Account IDs of the doorbell trigger component 201 that may be set by the administrator for the door phone device 20, and as mentioned above, the device administrator may further set receiving Account ID of the doorbell trigger component 201 so that is has doorbell device administrator identity. In contrast, as the login Account ID used by the controller is different from the login Account ID used by the door phone device 20 that sends trigger event notification to log in to the communication platform 24, as for the door phone device 20 that sends the trigger event notification, the controller 21 is only a recipient that receives the trigger notification, but does not have permission to manage or set the door phone device.

In summary, the controller using the door phone device may have three identities, the first one is to the controller of the door phone device administrator (that is, the controller using a login Account ID the same as the door phone device to log in to the communication platform), the second one is to the controller of the aforementioned doorbell device administrator, while the setting of the doorbell device administrator identity is determined by the controller which has the aforementioned door phone device administrator identity, the third one is the controller that does not have management permission but may only browse settings content of owned doorbell number or be notified with trigger event. Therefore, depending on settings or residence requirement of the door phone device, receiving Account IDs with different permissions may be set for doorbell numbers of the door phone device.

Further, after a device such as smart phone, portable electronic device with network connection function or computer device and etc. is installed and executes the doorbell application module 211, it may become the controller 21 of the invention, while the doorbell application module 211 is the aforementioned doorbell APP, the controller 21 communicates with external door phone device 20 or communication platform 24 through the communication module 210. As mentioned previously, because the door phone device 20 does not have network connection function upon production, it may connect with the door phone device 20 in advance with a wireless method through the communication module 210 of the controller 21 to set connection information and login Account ID/password used to the communication platform 24 for the door phone device 20. Besides, the communication module 210 of the controller 21 further provides internet link function for the controller 21 to connect and log in to the communication platform 24 to be able to connect with the door phone device 20 and acquires door control services such as visiting notification or audiovisual interaction with the visitor.

The login module 240 of the communication platform 24 is used to register a login Account ID, that is, a new login Account ID, and check the validity of the login Account ID/password and the APP ID of the controller 21, and will also check the validity of the login Account ID/password and the APP ID of the door phone device 20, to allow the door phone device 20 to log in and start the door control service it provides, and starts simultaneously the door phone device 20 and the controller 21 to provide audiovisual interaction service therebetween with respect to visitor trigger event. Therefore, the login module 240 creates controller identification information, inclusive of login Account ID, APP ID and IP connection according to the controller 21 that logs in successfully, while creates door phone device identification information, inclusive of login Account ID, APP ID and IP connection for the door phone device 20 that logs in successfully.

The search module 241 of the communication platform 24 utilizes the login Account ID/password input by the controller 21 to search for the IP connection method of the door phone device 20 that logs in with the same login Account ID, and provides the located IP connection method to the controller 21 for the controller 21 to perform connection with the door phone device 20 to be controlled according to the IP connection method, and set the receiving Account ID corresponding to it for the doorbell trigger component 201 of the door phone device 20. With the setting for the receiving Account ID of the doorbell trigger component 201, the door phone device 20 locates the IP connection method of the controller 21 to be interacted according to the receiving Account ID, and the door phone device 20 further checks the permission of control, access, management or browsing that may be performed by the controller for the door phone device 20 according to the login Account ID used by the controller that logs in to the communication platform. In addition, besides the real time interaction of aforementioned visitor video and audio information, the aforementioned interaction between the door phone device 20 and the controller 21 further includes activating and deactivating the door lock of the door phone device 20 controlled remotely by the controller. Briefly speaking, the interaction contents between the door phone device 20 and the controller 21 are all communicated and operated by the door control APP of the door phone device 20 and the doorbell APP of the controller 21.

From above, the door control system provided with door phone device addressing and door control service provided by the invention utilizes the controller to set necessary parameters for the door phone device to perform internet connection and log in to the communication platform, such method is very convenient compared to existing setting method. Additionally, if the door phone device to be set is already connected to the Internet and used the login Account ID/password and APP ID thereof to log in to the communication platform, the controller may connect to the door phone device and set correspondingly receiving Account ID for the doorbell trigger component on the door phone device by searching for the IP connection method of the door phone device according to the login Account ID of the door phone device through the communication platform only. Therefore, the arrangement of the door phone device and the setting of receiving Account ID are very convenient, and with the communication between door control APPs of the communication platform and the door phone device and the doorbell APP of the controller, even though the user is not home, the visiting message may still be sent immediately to the user at the controller end, and the user may also perform optionally audiovisual interaction with the visitor.

In summary, for the door control system provided with door phone device addressing and door control service and the controller, the door phone device and the communication platform according to the invention, the controller installed with and executes the doorbell APP, and the communication platform registers the APP ID of the doorbell APP, while the door phone device also is installed with and executes the door control APP, and the communication platform also registers the APP ID for the APP of the door phone device, the communication platform not only allows the controller and the door phone device to log in according to the login Account ID/password used for login, but also allows the controller and the door phone device to log in according to the registered APP ID, and the identification information of the controller and the door phone device is registered on the communication platform, and the controller and the door phone device that log in to the communication platform obtain the APP that may communicate and operate therewith mutually through respective APPs. Therefore, the major task of the communication platform is to support registration of new login Account ID, and verifies the controller and the door phone device that desire to log in with respect to the login Account ID/password and APP ID used by them for login (besides, the user or the administrator may also set APP Resource for the door phone device to classify different door phone devices depending on setup environment or user requirement of door phone devices), to allow or reject the controller or the door phone device to log in to the communication platform. Subsequently, the door phone device allowed to log in may publish its own IP connection method automatically, that is, the communication platform not only registers login Account ID of the door phone device and APP ID thereof (or including APP Resource), but also registers its IP connection method. The controller that logs in to the communication platform may locate the IP connection method of the door phone device that logs in with the login Account ID according to the login Account ID used by the door phone device. Therefore, the door control system provided with door phone device addressing and door control service and the controller, the door phone device and the communication platform may not only complete setup and settings for the door phone device quickly and easily, but also allow the user outdoors to learn the identity of the visitor and perform real time audiovisual interaction (that is, video and audio interaction) with the visitor anytime and anywhere.

What is claimed is:

1. A door control system provided with door phone device addressing and door control service, including:
a communication platform, which registers APP IDs of a doorbell APP and a door control APP, and provides a network device with services which include registering a login Account ID, logging and searching;
a controller, installed with said doorbell APP, executes said doorbell APP and registers a login Account ID/password used to log in to said communication platform, or logs in to said communication platform with said login Account ID/password that has been registered, and initiates a door phone device, and sends control commands to said door phone device; and
the door phone device, which is installed with said door control APP, and has at least one doorbell trigger component, executes said door control APP to receive said control commands sent by said controller which executes said doorbell APP, to set up Internet connection and login Account ID/password used to log in to said communication platform for said door phone device, to launch setup service; wherein, said controller is allowed to log in if said communication platform confirms the validity of APP ID, login Account ID/password of said controller; and said door phone device logs in with its login Account ID and publishes IP connection method of said door phone device to complete the addressing task for said door phone device if the APP ID and the login Account ID/password of said door phone device are confirmed as valid; said controller searches and acquires the IP connection method of said door phone device on the communication platform according to the login Account ID and the APP ID used by said door phone device to connect to said door phone device, and sets a receiving Account ID for the doorbell trigger component of said door phone device, while said receiving Account ID is coordinated in correspondence to said at least one doorbell trigger component, and the receiving Account ID that is set is stored by said door phone device, such that as soon as at least one doorbell trigger component receives a trigger event, said door phone device provides a notification of said trigger event to the receiving Account ID coordinated in correspondence to said at least one doorbell trigger component through said communication platform.

2. The door control system provided with door phone device addressing and door control service as claim 1, wherein, the controller and the door phone device that log in to said communication platform utilize said doorbell APP and said door control APP installed thereon respectively to locate the IP connection methods of each other according to the respective login Account IDs and APP IDs, and communicate and operate directly with each other.

3. The door control system provided with door phone device addressing and door control service as claim 1, wherein, said door phone device connects with said communication platform according to the connection information in said control command, and after said communication platform is logged in according to the login Account ID/password in said control command and the APP ID of the door control APP of said door phone device, identification information for the login Account ID, the APP ID and the IP connection method of said door phone device is published, and door phone device identification information of said door phone device is registered by said communication platform.

4. The door control system provided with door phone device addressing and door control service as claim 3, wherein, before said controller utilizes the IP connection method of said door phone device to connect therewith, said controller executes the following steps:
said controller executes said doorbell APP and logs in to the communication platform with the login Account ID/password;
said communication platform confirms that the received login Account ID/password and the APP ID of said doorbell APP are valid and allow said controller to log in;
the doorbell APP of said controller utilizes said login Account ID and the APP ID of the door control APP of the door phone device to search, on the communication platform, for the door phone device using the same login Account ID to log in to said communication platform and acquire the IP connection method thereof; and
the doorbell APP of said controller utilizes the IP connection method of said located door phone device to connect to said door phone device, to set up the receiving Account ID in correspondence to the at least one doorbell trigger component of said door phone device.

5. The door control system provided with door phone device addressing and door control service as claim 4, wherein, as the login Account ID used by said door phone device is the same as the login Account ID used by the controller, it indicates that said controller is a device administrator of the door phone device, and the door phone device allows said controller to manage it.

6. The door control system provided with door phone device addressing and door control service as claim 5, wherein, after said controller utilizes the IP connection of said door phone device to connect therewith, said controller with the device administrator identity sets a receiving Account ID that grants access to said doorbell trigger component for the at least one doorbell trigger component of said door phone device.

7. The door control system provided with door phone device addressing and door control service as claim 6, wherein, as there are multiple said receiving Account IDs, the controller with the device administrator identity sets a receiving Account ID from said multiple receiving Account IDs as doorbell device administrator; said doorbell device administrator has permission to check and manage said doorbell trigger component.

8. The door control system provided with door phone device addressing and door control service as claim 1, wherein, the login Account ID used by the controller that executes said doorbell APP to log in to said communication platform is equal to the receiving Account ID set by the doorbell trigger component of said door phone device, and as the login Account ID used by said controller differs from the login Account ID used by said door phone device, it indicates that the controller using said login Account ID is only to receive trigger event notification provided by said door phone device.

9. A controller, which connects, through a communication platform, a door phone device that logs in to said communication platform, for said controller and said door phone device to interact; said door phone device has a door control application module; and said communication platform stores, for said door phone device that has logged in, door phone identification information, inclusive of a login Account ID thereof, an APP ID of said door control application module and an IP connection method thereof; said controller includes:
a communication module, which is used to connect said door phone device and/or said communication platform;
a doorbell application module, which is used to output login Account ID/password for logging in to said communication platform through said communication module and to output a control command to interact with said door phone device; wherein, said communication platform stores, for said controller that logs in, controller identification information, inclusive of login Account ID thereof, APP ID of said doorbell application module and IP connection method thereof, for the door phone device that logs in to said communication platform to connect the controller to be searched with the IP connection method in said controller identification information, or for the controller that logs in to said communication platform to connect the door phone device to be searched with the IP connection method in said door phone device identification information, and after both thereof are connected, interaction is enabled on respective doorbell application module and door control application module thereof.

10. The controller as claim 9, wherein, said door phone device has at least one doorbell trigger component, as the login Account ID used by said controller to log in to said communication platform is the same as the login Account ID used by the door phone device, said controller is the device administrator of said door phone device; the interaction process between said doorbell application module and said door control application module includes: said doorbell application module sets a receiving Account ID for the doorbell trigger component of said door phone device, and said door control application module stores the receiving Account ID corresponding to said doorbell trigger component set by the aforementioned interaction process on the door phone device, such that once said doorbell trigger component receives a trigger event, the door phone device searches IP connection method of the receiving Account ID through said communication platform to provide a notification of said trigger event to the receiving Account ID set in correspondence to said doorbell trigger component.

11. The controller as claim 10, wherein, the interaction process of said doorbell application module and said door control application module further includes: said doorbell application module performs set-up with respect to adding or deleting said receiving Account ID for the doorbell trigger component of said door phone device, setting whether or not said doorbell trigger component starts automatic answering and uploading recorded answering audio, setting whether or not said doorbell trigger component records visitor audio or image on said door phone device, or setting cloud storage Account ID/password used by said doorbell trigger component to store recorded visitor video and audio; and said door control application module stores setting result of the aforementioned interaction process on the door phone device.

12. The controller as claim 10, wherein, as there are multiple receiving Account IDs for the doorbell trigger component of said door phone device, the controller with the device administrator identity sets one receiving Account ID from said multiple receiving Account IDs as doorbell device administrator; said doorbell device administrator has permission to check and set up said doorbell trigger component.

13. The controller as claim 9, wherein, the door control application module of said door phone device receives said control commands from the doorbell application module of said controller; said control commands include connection information used to connect the Internet and the login Account ID/password used to log in to said communication platform, for said door phone device to log in to said communication platform and completes the setting.

14. a door phone device, which connects a controller through a communication platform, for said controller and said door phone device to send notification with respect to the event of visiting, wherein, said controller has a doorbell application module, said communication platform stores for said controller that has logged in, controller identification information, inclusive of login Account ID thereof, APP ID of said doorbell application module and IP connection method thereof; said door phone device includes:
an video and audio process component;
a doorbell trigger component, which is used to generate a trigger event of said visiting; and
a control chip, which is used to provide networking function, and has a door control application module, after said communication platform logs in through said networking function, said communication platform stores, for said door phone device that has logged in, door phone device identification information, inclusive of login Account ID thereof, APP ID of said door control application module and IP connection method thereof, for the controller that logs in to said communication platform to check and acquire the IP connection method in the identification information on the communication platform with the login Account ID and the APP ID of said door phone device, or for the controller that logs in to said communication platform to connect the door phone device to be searched by the IP connection method in said door phone device identification information, wherein, said door control application module stores a receiving Account ID corresponding to said doorbell trigger component, such that as said doorbell trigger component receives said trigger event, the IP connection method of the controller that logs in with the receiving Account ID is located through said communication platform, to provide a notification of said trigger event to the receiving Account ID set in correspondence to said doorbell trigger component, while said receiving Account ID is the login Account ID used by said controller to log in to said communication platform.

15. The door phone device as claim 14, wherein, as the login Account ID used by said controller to log in to said communication platform is the same as the login Account ID used by the door phone device, said controller is a device administrator of said door phone device, and the receiving Account ID of the doorbell trigger component of said door phone device is set by the controller with the device administrator identity.

16. The door phone device as claim 15, wherein, after said controller with the device administrator identity connects said door phone device though said communication platform, the interaction process performed by both includes: the doorbell application module of said controller performs the setting of adding or deleting said receiving Account ID for the doorbell trigger component of said door phone device, setting that whether or not said doorbell trigger component starts automatic answering and uploading recorded answering audio, setting cloud storage Account ID/password of used by said doorbell trigger component to store recorded video and audio; and said door control application module stores setting result of the aforementioned interaction process on the door phone device.

17. The door phone device as claim 15, wherein, as there are multiple receiving Account IDs for the doorbell trigger component of said door phone device, the controller with the device administrator identity sets a receiving Account ID from said multiple receiving Account IDs as doorbell device administrator, said doorbell device administrator has permission to check and set up said doorbell trigger component.

18. The door phone device as claim 14, wherein, the door control application module of said door phone device receives said control commands from the doorbell application module of said controller, said control command includes connection information used to connect the Internet and the login Account ID/password used to log in to said communication platform, for said door phone device to log in to said communication platform and complete the setting.

19. A communication platform, which is used to provide connection process for a controller and a door phone device, and said controller installed with doorbell APP which is running, while said door phone device installed with door control APP which is running; said communication platform includes:
a login module, used to register login Account IDs/passwords for said controller or said door phone device, and recording valid login Account IDs/passwords, and recording valid APP ID of the doorbell APP, and recording valid APP ID of the door control APP, and after said controller or said door phone device is confirmed cleared for login, stores identification information, inclusive of login Account ID, APP ID thereof and IP connection method; and
a search module, used for the controller or the door phone device logged in to said communication platform to search the IP connection method of the controller or the door phone device to be connected on the communication platform to connect through the login Account ID of the controller or the door phone device to be connected and the APP ID thereof.

20. The communication platform as claim 19, wherein, said door phone device has a doorbell trigger component used to generate a trigger event with respect to visiting, after the controller logged in to said communication platform utilizes said door phone device identification information to connect the door phone device to be searched, as the door control APP of said door phone device confirms that the login Account ID used by the controller connecting therewith is the same as the login Account ID used by said door phone device, said door phone device allows said controller to set a receiving Account ID of the door trigger component thereof, and said receiving Account ID is the login Account ID used by said controller to log in to said communication platform, and said receiving Account ID that is set is stored in the local by said door phone device, such that a said doorbell trigger component generates said trigger event, the notification of said trigger event is provided to the receiving Account ID set in correspondence to said doorbell trigger component through the controller identification information stored by said communication platform.
